(19) United States
(12) Patent Application Publication
(10) Pub. No.: US 2025/0055124 A1
(43) Pub. Date: Feb. 13, 2025

(54) PRISMATIC BATTERY CELL AND BATTERY MODULE

(71) Applicant: AUDI AG, Ingolstadt (DE)

(72) Inventors: Michael ERNST, Wüstenrot (DE); Arjan STRATING, Weinsberg (DE)

(73) Assignee: AUDI AG, Ingolstadt (DE)

(21) Appl. No.: 18/775,407

(22) Filed: Jul. 17, 2024

(30) Foreign Application Priority Data
Aug. 10, 2023 (DE) 102023121412.8

(51) Int. Cl. H01M 50/383; H01M 50/103; H01M 50/342

(52) U.S. Cl. CPC H01M 50/383; H01M 50/103; H01M 50/3425; H01M 2200/20

(57) ABSTRACT

A prismatic battery cell including a cell housing made of a first material. The cell housing includes a first cell wall with a releasable cell degassing opening. The battery cell includes a heat protection element with a base element which is formed from a second material which has a higher melting point than the first material, and which has two opposing side tabs and a base plate which connects these via a respective protective edge and has a through-opening. The base plate is arranged flat against the first cell wall or is integrated into the first cell wall so that the through-opening overlaps with the releasable cell degassing opening, and the respective first and second protective edges overlap with at least part of the respective first and second edges or are integrated into them.

### FIELD

The invention relates to a prismatic battery cell having a cell housing comprising a first and a second cell wall which are opposite with respect to a first direction, a third and a fourth cell wall which are opposite with respect to a second direction, and a fifth and a sixth cell wall which are opposite with respect to a third direction. The first cell wall adjoins the third cell wall via a first edge, the fourth cell wall via a second edge, the fifth cell wall via a third edge and the sixth cell wall via a fourth edge. The first and the second edge are each longer than the third edge and the fourth edge, wherein the battery cell comprises a releasable cell degassing opening which is arranged in the first cell wall. Furthermore, the invention also relates to a battery module with such a prismatic battery cell.

### BACKGROUND

Prismatic battery cells, in particular those for batteries for motor vehicles, often have a releasable cell degassing opening, for example a bursting membrane, in order to enable defined outgassing of the battery cell in the event of thermal runaway of such a battery cell. However, in so-called thermal propagation tests, which are carried out to investigate the propagation behavior of such battery cells, it has been found that in some cases the battery cells may not propagate or out-gas through the burst valve specifically designed for this purpose, but that a larger area around the burst valve may also be destroyed. This makes it difficult to specifically remove a gas escaping from such a propagating cell and to specifically introduce such a gas into a gas removal channel. If gas escapes from the cell in places that are not intended for it, there is a risk that the gas escaping there cannot be removed in a targeted manner and may end up in areas where it should not. In particular, such gas can come into contact with neighboring cells and damage and heat them, causing them to thermally run away as well. If such a neighboring cell is damaged, for example, by the hot gas of the outgassing cell in a certain housing region, this leads to a further weak point in the housing, which can be destroyed all the more easily by the internal gas pressure in the event of propagation of this neighboring cell, so that outgassing of this neighboring cell may not occur at all through the burst valve provided for this purpose, but additionally or alternatively via this weak point. This makes it impossible or very difficult to control the propagation behavior of multiple cells. However, a more robust design of the cells results in more weight, more required installation space and more costs.

DE 10 2022 001 413 A1 describes a battery cell housing for a battery cell of a battery module, with an interior and with an outer wall which has an overpressure element which is designed to release particles from the battery cell in the event of a thermal runaway of the battery cell. The battery cell housing comprises a filter plate which is arranged on the outer wall and at least partially covers an outlet opening of the overpressure element. A spacer element is formed between the filter plate and the outer wall, by means of which a particle gap is formed for adjusting a particle size. The filter plate comprises a curved side surface which projects beyond the outer wall at least in parts. The curved side surfaces allow the gas outflow to be directed in specific directions.

However, the problems described above still remain.

### SUMMARY

The object of the present invention is to provide a prismatic battery cell and a battery module which enable outgassing of the prismatic battery cell with the highest possible probability via the releasable cell degassing opening provided for this purpose in a manner which saves as much installation space, saves weight and is as efficient as possible.

A prismatic battery cell according to the invention comprises a cell housing of a first material, wherein the cell housing comprises a first and a second cell wall which are opposite with respect to a first direction, a third and a fourth cell wall which are opposite with respect to a second direction, and a fifth and a sixth cell wall which are opposite with respect to a third direction. The first cell wall adjoins the third cell wall via a first edge, the fourth cell wall via a second edge, the fifth cell wall via a third edge and the sixth cell wall via a fourth edge, the first and the second edge each being longer than the third edge and the fourth edge, the battery cell comprising a releasable cell degassing opening arranged in the first cell wall. The battery cell has a heat protection element which comprises a base element which is formed from a second material which has a higher melting point than the first material, wherein the base element has a first side tab and a second side tab which are opposite one another with respect to the second direction, and a base plate which connects the first and second side tabs via a respective first and second protective edge and has a through-opening, wherein the base plate is arranged flat against the first cell wall or is integrated into the first cell wall so that the through-opening overlaps with the releasable cell degassing opening, and the respective first and second protective edges overlap with or are integrated into at least part of the respective first and second edges.

The invention is based on several findings: Firstly, it is very advantageous, especially with regard to weight, cost and installation space efficiency, to form the cell housing from a material that is as cost-effective and thin-walled as possible. However, such a design usually does not withstand the high stresses in the event of thermal runaway of such a battery cell. However, as described, a globally more robust design of the cell housing leads to more weight, more costs and more installation space. This can advantageously be avoided by providing a heat protection element which allows local reinforcement of the cell housing of the prismatic battery cell without having to make the entire cell housing more robust. By means of the heat protection element, it is advantageously possible to protect and reinforce particularly weak points of the cell housing in the event of propagation of the battery cell. Furthermore, the invention is based on the finding that such weak points of the cell housing are not only found around the releasable cell degassing opening on the first side of such a prismatic battery cell, but that above all the edges of such a cell housing represent such weak points. This mainly affects the longitudinal edges of the cell housing adjacent to the first side. It is precisely these longitudinal edges of the cell housing that can now be specifically reinforced and protected using the protective edges of the heat protection element. It is therefore much less likely that the cell housing will tear open in the area of these edges, and the targeted outgassing of the battery cell in the event of propagation is promoted via the cell degassing opening provided for this purpose.

The releasable cell degassing opening can be designed as a pressure-dependent and passively releasable cell degassing opening. For example, the cell degassing opening may be provided as a pressure relief valve and/or a bursting membrane. Since the battery cell is a prismatic battery cell, it has an essentially cuboid-shaped cell housing. The cell walls opposite each other with respect to the same direction thus have essentially the same dimensions and the same geometry, in particular rectangular geometry. Accordingly, the first and second edges are essentially the same length, as are the third and fourth edges. An edge can also be understood to mean a rounded edge. Such an edge represents the transition region between two cell walls.

The cell housing separates an interior of the battery cell, which can also be referred to as the interior of the battery cell, from the environment of the battery cell. The cell housing may accordingly have an outer side or outer surface facing the environment and an inner side facing the interior of the battery cell. In addition, the battery cell comprises two cell poles, which can be provided on any of the cell walls of the battery cell. For example, the two cell poles can also be located on or in the first cell wall, or one cell pole can be located on the fifth and the other on the sixth cell wall.

The heat protection element can generally be designed as a separate component, i.e. separate from the cell housing, and arranged accordingly on the cell housing, or the heat protection element can also be integrated into the cell housing. In this case, the base plate can be integrated into the first cell wall in such a way that it is enclosed, for example, between wall elements of the first cell wall and the base plate is accordingly located between the two wall elements with respect to the first direction. The base plate can also be integrated into the first cell wall in such a way that it forms part of the first cell wall. In other words, the cell wall in the region in which the base plate is arranged may be formed only by the base plate. The same applies to the corresponding side tabs and protective edges.

The heat protection element can still be provided by the base element alone. In other words, the base element can form the heat protection element. Alternatively, the heat protection element can, for example, have, in addition to the base element, a coating with which the base element is coated. In this case, the heat protection element is provided or formed by the base element coated with the coating. The coating can be made of a different material than the second material. The coating can, for example, be an anti-corrosion coating. This provides a larger selection of materials for the second material.

The base plate is arranged on the first cell wall or integrated into the first cell wall in such a way that the through-opening overlaps with the releasable cell degassing opening. This should be understood to mean that the releasable cell degassing opening is not covered or concealed by any part of the base plate. The through-opening can have essentially the same geometry as the releasable cell degassing opening. The edge region circumferentially delimiting the through-opening can be arranged on the edge region circumferentially delimiting the releasable cell degassing opening or can be adjacent to it. The boundary contour of the through-opening can in particular directly border on the boundary contour of the releasable cell degassing opening.

Furthermore, it is preferred that the base element does not have any further openings or holes or the like apart from the through-opening. The heat protection element can, for example, have an outer contour which represents a boundary contour of the heat protection element, wherein the heat protection element is designed as a continuous wall within its outer contour except for the through-opening. This allows the protective effect of the heat protection element to be maximized. The heat protection element can thus cover regions of the cell housing and efficiently prevent bursting, breaking or other destruction of the cell housing in the event of propagation of the battery cell, or at least significantly reduce the likelihood of this happening.

In a further advantageous embodiment of the invention, the first side tab lies flat against the third cell wall or is integrated into it, and the second side tab lies flat against the fourth cell wall or is integrated into it. The side tabs can also be plate-shaped elements, similar to the base plate. In general, the base plate and the side plates each have a length and a width that is greater than their thickness, whereby the thickness of the base plate and the side plates is also referred to as the wall thickness. The thickness of the base plate extends in the first direction, while the thickness of the side tabs extends in the second direction. The side tabs can basically have any geometry, but preferably also have a rectangular geometry. The base element can, for example, be designed in the form of a U-profile with a through-opening in the base plate. The two legs of this “U” of the U-profile are provided by the two side tabs.

The side tabs can also be integrated into the cell housing as already described for the base plate. Accordingly, the first side tab can also be integrated into the third cell wall and represent a part of this third cell wall or be embedded in wall elements of the third cell wall, and accordingly, the second side tab can be integrated into the fourth cell wall or represent a part of this fourth cell wall or be embedded in wall elements of the fourth cell wall.

However, it is very advantageous and preferred if the heat protection element is designed as a component separate from the cell housing. This advantageously makes it possible to retrofit conventional battery cells with such a heat protection element. This can, for example, simply be arranged on the outside of the cell housing, as explained in more detail later. This advantageous protection mechanism is therefore also available as a retrofit solution for existing battery cells. In addition, the manufacturing process for existing battery cells can be retained and simply supplemented with the formation and attachment of the heat protection element.

This enables particularly simple and efficient production of the prismatic battery cell.

Therefore, it represents a further very advantageous embodiment of the invention if the heat protection element is a component separate from the cell housing and is arranged on an outer side of the cell housing. In this example, the base plate is arranged flat against the outside of the first cell wall, the first side tab is arranged flat against the outside of the third cell wall and the second side tab is arranged flat against the outside of the fourth cell wall. The first protective edge thus covers the first edge of the cell housing on the outside, and the second protective edge correspondingly covers the second edge of the cell housing on the outside. A tearing of the cell housing in the area of these edges and a gas leakage over these edges in the event of propagation of the battery cell can thus be prevented much more efficiently.

According to a further embodiment of the invention, the heat protection element is a component separate from the cell housing and is arranged on an inner side of the cell housing inside the cell housing. In principle, it is also possible to provide the heat protection element inside the cell housing. Here too, the heat protection element or the base element, as previously described, is arranged flat against the corresponding cell walls, but in this case now on the inside in relation to the cell housing. This can also achieve a reinforcing effect. However, the integration into the cell housing already takes place during the manufacturing process of the cell housing. This makes it difficult to use the heat protection element as a retrofit solution. However, this variant has the great advantage that the heat protection element, if arranged in the interior of the battery cell, can be held much more stably to the cell housing in the event of propagation of the battery cell. Melting of the cell housing in regions where the heat protection element is located can thus be prevented even more effectively.

The first material is preferably aluminum. Aluminum has the great advantage that it is very light and inexpensive, and allows for easy production of a cell housing. The cell housing can be formed, for example, using a deep drawing process.

According to a further advantageous embodiment of the invention, the second material has a melting point of at least 1300° C., in particular at least 1400° C. This is based on the knowledge that cell propagation produces temperatures in the range between 800° C. and 1300° C. This means that the heat protection element can advantageously withstand such high temperatures. The second material is preferably a metal or an alloy. In principle, other materials, such as ceramic, can also be used. However, a metallic material has the great advantage that it generally allows a significantly thinner-walled heat protection element. This allows the heat protection element to be provided in a particularly space-saving manner. Particularly preferably, the heat protection element or its base element is made of steel or stainless steel. Stainless steel is particularly preferred because it is corrosion-resistant, especially to aluminum, and therefore the base element does not need to be provided with an additional coating for corrosion protection. The heat protection element can, for example, be made entirely of stainless steel.

In a further very advantageous embodiment of the invention, the base element, and in particular the heat protection element, has a wall thickness of a maximum of 2 mm or a maximum of 1 mm, preferably a maximum of 0.5 mm. This allows the basic element to be provided in a particularly space-saving manner. Depending on the material and requirements, even smaller wall thicknesses are conceivable, for example in the range between 0.2 mm and 0.4 mm, or even wall thicknesses of less than 0.2 mm, for example in the range of 0.05 mm.

Such a thin-walled design of the heat protection element therefore hardly results in any additional weight, and there are essentially no additional installation space requirements. The heat protection element can therefore be easily integrated, for example, into a battery module with multiple prismatic battery cells, without having to change the module structure or reposition other components.

In a further advantageous embodiment of the invention, the first protective edge covers a major part of the first edge in the third direction and the second protective edge covers a major part of the second edge in the third direction. In principle, it is also conceivable that the first and second protective edges each cover more than the majority of the first or second edge or even cover them completely in the third direction. Here, too, covering is possible on the inside and outside. Here, too, there is the possibility that the heat protection element is integrated into the cell housing and thus the first protective edge is embedded in the first edge and the second protective edge is embedded in the second edge or the respective protective edges represent the corresponding edges of the cell housing or at least form them for the most part.

Thus, the corresponding edges of the cell housing can be particularly well protected and reinforced by means of the protective edges. If, for example, the cell poles of the prismatic battery cell are located in or on the first cell wall, it is preferred that the releasable cell degassing opening is located between the two cell poles with respect to the third direction and that the two cell poles are arranged as far as possible with respect to the third direction at the edge of the first cell side or the first cell wall. In this case, the base plate can extend in the third direction up to the cell poles or almost up to the cell poles, for example up to a predetermined distance, which can be less than 1 cm, in particular less than 0.5 cm. If the cell poles are not located on the first cell wall or in the first cell wall, but on other cell walls of the cell housing, the base plate in the third direction can also extend over the entire length of the first cell wall in the third direction. Accordingly, in this case the protective edges can also extend over the entire first and second edge of the cell housing in the third direction. This advantageously offers maximum edge protection.

In a further advantageous embodiment of the invention, the first and/or second side tabs have a height in the first direction which is at least 5 mm, in particular at least 1 cm, and/or a maximum of half a wall height of the third cell wall in the first direction. The wall height of the third cell wall essentially corresponds to the wall height of the fourth cell wall. The side tabs therefore preferably extend up to a maximum of half the cell height of the battery cell or the housing height in the third direction downwards or upwards, depending on the positioning of the first cell wall. Complete coverage of the third and fourth cell walls in the third direction by the side tabs is not necessarily required. This is based on the finding that the third and fourth cell walls in the cell composite, for example when the prismatic battery cell is located in a cell stack with several other prismatic battery cells, are laterally covered and supported by additional components, in particular so-called cell separating elements, which can be arranged between the cells. Outgassing of the cell during propagation via the third and fourth cell walls, particularly in a central region of these cell walls, is hardly possible due to the support provided by these other components. Furthermore, this embodiment is based on the knowledge that such cell separation elements generally do not extend over the entire height of the cell or the cell housing in the third direction and that, for example, an edge region of the third and fourth cell wall, which borders on the first cell wall or the first and second edge, is not covered by such a cell separation element. Therefore, these edge regions of this third and fourth cell wall represent a weak point. These can advantageously be covered by the side tabs of the base element. For this purpose, a height of the corresponding tabs in the first direction in the range of, for example, 1 to 2 cm is completely sufficient. The side tabs can therefore be limited to a height in the first direction of approximately 1 cm to 5 cm, in particular 1 cm to 2 cm.

In a further advantageous embodiment of the invention, the first side tab extends in the first direction over the entire third cell wall and/or the second side tab extends in the first direction over the entire fourth cell wall, in particular wherein the base element has a first base tab and a second base tab which are opposite the base plate with respect to the first direction, wherein the first side tab is connected to the first base tab via a third protective edge and the second side tab is connected to the second base tab via a fourth protective edge, wherein the first and second base tabs are each arranged on the second cell side or are integrated therein, and the respective third and fourth protective edge overlap with or are integrated into at least part of a respective fifth edge connecting the third and second cell sides and a sixth edge connecting the fourth and second cell sides.

The side tabs can also extend in the first direction over the entire third or fourth cell wall. This allows these cell walls to be further stabilized and protected from damage when the cell outgasses. In particular, it is also possible to allow the base element to enclose the lower second cell side and thereby to stabilize and protect the fourth edge, which connects the third and second cell sides, and/or the fifth edge of the cell housing, which connects the fourth and second cell side, by covering them with the corresponding third or fourth protective edges or by integrating these protective edges into the housing edges. Above all, enclosing the fourth and fifth edges can serve to create a mechanical anchoring of the heat protection element.

It is also conceivable to design the two base tabs as a common base tab that lies flat against the second cell side. However, it simplifies the manufacture and attachment of the heat protection element to the cell housing if the two base tabs are separated from each other and not connected to each other. The base tabs are also preferably arranged flat on the second cell side, but do not completely cover it in the second direction.

In a further advantageous embodiment of the invention, at least one recess or through-opening is arranged in the first and/or second side tab, in particular in a lower half of the first or second side tab facing away from the base plate, without being necessarily limited to the lower half. The two side tabs can, for example, be formed in the lower half with a partially reduced wall thickness in order to provide such a recess, or even with one or more through-openings, such as holes, which penetrate the respective side tabs in the second direction. This allows the heat protection element to be made lighter and more cost-effective, which is particularly advantageous when the side tabs extend over the entire third or fourth cell side in the first direction. Then an additional stabilizing effect can be provided without having to require significantly more weight and material.

According to a further advantageous embodiment of the invention, the heat protection element is glued and/or clipped and/or held by friction to the cell housing. In principle, these connection options can also be combined in any way. Adhesive bonding is particularly advantageous here, as it can provide a stable connection between the heat protection element and the cell housing without having to provide additional elements, such as locking lugs or clip elements on the heat protection element and/or the cell housing. However, it is also possible to clip the heat protection element onto the cell housing. For this purpose, the heat protection element and/or the cell housing can be designed with a corresponding locking mechanism which makes it possible to hold the heat protection element on the cell housing by locking, in particular by positive locking. In this case, it is preferred to provide such a clip or locking structure on the first cell wall, such as in the region of the releasable cell degassing opening or its edge, and correspondingly on the base plate of the heat protection element. A fastening by frictional connection is also conceivable. This frictional connection can also be provided by other components that press the heat protection element partially against the cell housing of the prismatic battery cell. For example, if the prismatic battery cell is arranged in a cell assembly with multiple cells, the side tabs can be clamped in the region between the cells. Alternatively or additionally, such a battery module, which comprises the prismatic battery cell, can also have, for example, a cell cover or another cover structure which holds the heat protection element to the cell housing and which is arranged, for example, with respect to the first direction above the first cell wall and the base plate of the heat protection element. Such a component can press the heat protection element downwards against the cell housing with respect to the first direction.

Furthermore, the invention also relates to a battery module with a prismatic battery cell according to the invention or one of its embodiments.

The advantages described in relation to the prismatic battery cell and its embodiments apply in the same way to the battery module according to the invention.

In a further very advantageous embodiment of the battery module, the battery module comprises at least one component which is in contact with at least a part of the heat protection element and holds the heat protection element on the outside of the cell housing by means of frictional engagement and/or positive engagement. This advantageously makes it possible to provide a holder, in particular an additional holder, or fixation of the heat protection element on the cell housing.

This component can be, for example, a further battery cell, in particular a further battery cell according to the invention or one of its embodiments, and/or a cell separating element arranged between two battery cells, wherein at least one of the battery cells represents a prismatic battery cell according to the invention or one of its embodiments, and/or this component can be a module cover and/or a housing base and/or a carrier plate for cell connectors and/or a cooling plate or the like.

For example, the battery module can comprise a plurality of prismatic battery cells, in particular a plurality of battery cells according to the invention or battery cells according to exemplary embodiments of the invention, which are arranged next to one another in a stacking direction, wherein the stacking direction corresponds to the second direction defined above. A cell separation element can be arranged between every two battery cells arranged adjacent to each other in the stacking direction. The cell separation element can be designed as a flat element which has a length and a width in the first and third directions which are significantly greater than its thickness in the second direction. Furthermore, it is preferred that the cell separating element has a height in the first direction which is less than the height of the third and fourth cell walls in the first direction. The cell separating element can be spaced apart from a respective first cell side of the adjacent battery cells with respect to the first direction. An above-mentioned cover, for example a battery housing cover or module cover or also a cooling plate or carrier plate for the cell connectors is preferably arranged above and/or below the cell stack with the plurality of battery cells with respect to the first direction, in particular such that the respective first cell walls face this cover or this plate. Such a plate or such a cover can also be mounted on the cell stack or fixed in relation to the cell stack, for example screwed on at the end or similar.

Furthermore, the invention also relates to a battery, in particular a motor vehicle battery, which comprises at least one battery module according to the invention or one of its embodiments. The battery can also have multiple such battery modules. The battery can be designed, for example, as a high-voltage battery. The battery cells can be formed as lithium-ion cells, for example.

Furthermore, the invention also relates to a motor vehicle having a battery module according to the invention or one of its embodiments.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic and perspective representation of a prismatic battery cell according to an exemplary embodiment of the invention;

FIG. 2 shows a schematic and perspective representation of a prismatic battery cell according to a further exemplary embodiment of the invention.

FIG. 3 shows a schematic cross-sectional representation of a prismatic battery cell according to one exemplary embodiment of the invention;

FIG. 4 shows a schematic cross-sectional representation of a prismatic battery cell according to another exemplary embodiment of the invention;

FIG. 5 shows a schematic representation of a battery module having multiple prismatic battery cells according to an exemplary embodiment of the invention; and

FIG. 6 shows a schematic and perspective representation of a prismatic battery cell according to a further exemplary embodiment of the invention.

### DETAILED DESCRIPTION

The exemplary embodiments explained below are preferred embodiments of the invention.

In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

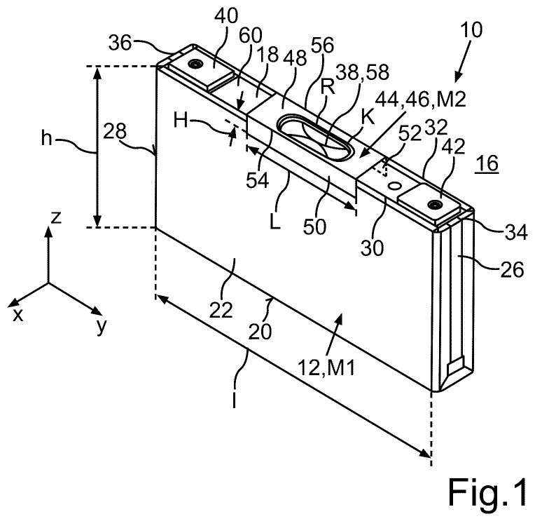

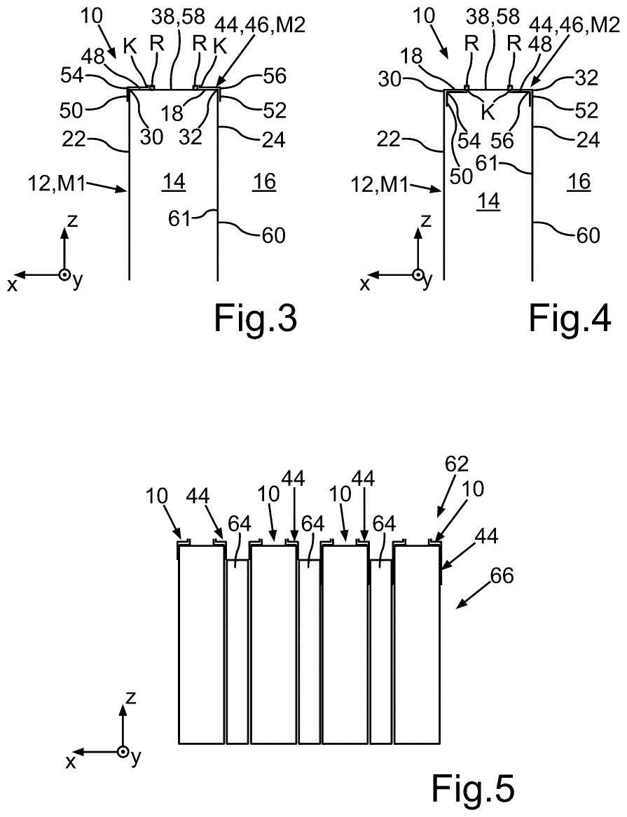

FIG. 1 shows a schematic representation of a prismatic battery cell 10 according to an exemplary embodiment of the invention. The battery cell 10 has a cell housing 12. The cell housing 12 encloses an interior space 14 (cf. FIG. 3 and FIG. 4) and separates this interior space 14 from an environment 16 of the battery cell 10. The cell housing 12 has a first cell wall 18 and a second cell wall 20 opposite with respect to the z-direction, a third cell wall 22 and a fourth cell wall 24 opposite the third cell wall 22 (cf. FIG. 3 and FIG. 4), as well as a fifth cell wall 26 and a sixth cell wall 28 opposite the fifth cell wall 26 with respect to the y-direction. The z-direction shown was previously also referred to as the first direction, the y-direction as the third direction and the x-direction as the second direction.

The first cell wall 18 adjoins the third cell wall 22 via a first edge 30, the fourth cell wall 24 via a second edge 32, the fifth cell wall 26 via a third edge 34 and the sixth cell wall 28 via a fourth edge 36. The edges 30, 32 represent longitudinal edges, and the edges 34, 36 represent transverse edges which are shorter in the x-direction than the longitudinal edges 30, 32 in the y-direction.

In the first cell wall 18, a releasable cell degassing opening 38 of the battery cell 10 is arranged, which is designed, for example, as a bursting valve or bursting membrane. In the present case, this is arranged centrally in the first cell wall 18 with respect to the y-direction, as well as centrally with respect to the x-direction. In addition, the battery cell 10 comprises two cell poles 40, 42. In the example shown here, these are also arranged on the first cell wall 18. In principle, however, these can also be arranged on any other cell wall of the battery cell 10. The described cell walls 18, 20, 22, 24, 26, 28 are preferably made of aluminum. The battery cell 10 advantageously comprises a heat protection element 44. This has a base element 46, which is composed of a base plate 48, a first side tab 50 and a second side tab 52, wherein the second side tab 52 is shown in dashed lines here, since it is located on the rear cell wall 24 according to the illustration in FIG. 1. The two side tabs 50, 52 are connected to one another via the base plate 48, in particular via a respective first and second protective edge 54, 56. The base plate 48 has a through-opening 58 which has essentially the same geometry as the releasable cell degassing opening 38 and is arranged congruently above it. The base plate 48 thus lies flat against the first cell wall 18, in particular in this example on the outside of the cell wall 18, namely on an outer side 60 of the cell housing 12. The first side tab 50 lies flat against the third cell wall 22, in particular also on the outside, and the second side tab 52 correspondingly lies on the outside of the fourth cell wall 24, in particular also flat. The protective edges 54, 56 thus cover a part, e.g. at least one third, of the edges 30, 32 of the cell housing 12 in the y-direction. The heat protection element 44 or at least its base element 46 is formed from a second material M2, which has a significantly higher melting point than the first material M1 of the cell housing 12, which is preferably aluminum. The second material M2 can be, for example, steel or preferably stainless steel. Optionally, a protective layer can also be arranged on the base element 46. This can, for example, also be located only on the contact side of the base element 46 facing the cell housing 12 in order to provide corrosion protection. However, the heat protection element 44 can also be formed only by the described base element 46. The heat protection element 44 can be designed, for example, as a protective plate made of thin-walled stainless steel, for example with a wall thickness in the range of 0.2 mm to 0.4 mm, with a melting temperature of approx. 1500° C. As a result of this and the described geometric design of this protective plate 44, the area surrounding the burst valve, namely the releasable cell degassing opening 38, can be protected both mechanically and thermally in a targeted manner without restricting the function of the extremely tightly tolerated battery module 62 (see FIG. 5). The protective sheet 44 can, for example, simply be placed on the cell from above, namely on the cell housing 12, and glued together with an insulating film that additionally envelops the cell housing 12, but which is not shown here. It is also conceivable for the heat protection element 44 to be mechanically clipped, for example at the edge of the burst valve 38. In any case, the heat protection element 44 can now advantageously ensure that in the event of propagation, the thin-walled battery cell or the cell housing 12 made of aluminum is sufficiently protected in order to allow the propagation to take place in a targeted manner only via the hole of the burst valve 38 and thus above all to protect neighboring cells from further propagation. A cell separating element 64 (see FIG. 5) can then also reliably perform its intended task and protect the neighboring cells from thermal runaway.

Thus, conventional prismatic battery cells can be made safer through such a simple optimization measure. The heat protection element 44 can also be provided as a retrofit solution so that previously used battery cells can continue to be used. A so-called thermal runaway, in which more and more cells are infected by a propagating cell, can be significantly delayed or, in the best case, even completely prevented by the provision of such a protection element 44.

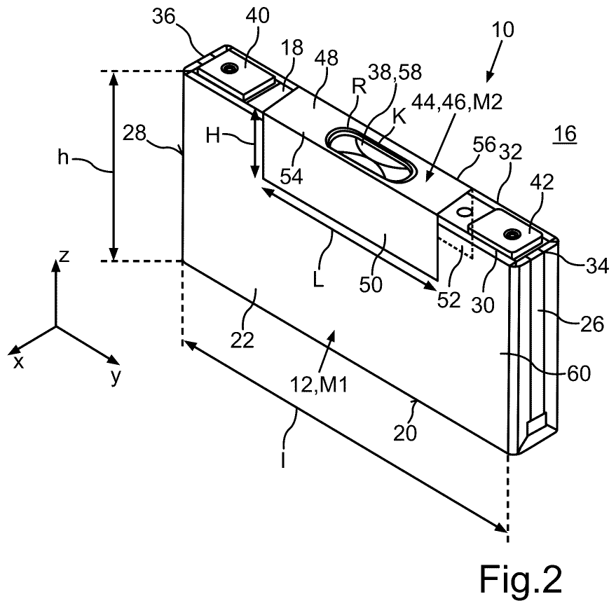

In the present case, the base plate 48 and the side tabs 50, 52 have a length L in the y-direction and the side tabs 50, 52 have a height H in the z-direction. The third cell wall 22 and correspondingly also the fourth cell wall 24 have a length 1 in the y-direction and a height h in the z-direction. The length L of the base plate and the side tabs 50, 52 extends, for example, in the y-direction over at least a third of the length 1 of the third cell wall 22, or also over a larger region, as shown by way of example in FIG. 2, for example over at least half the length 1 of the third side wall 22. The heat protection element 44 can also extend over the entire region between the cell poles 40, 42 in the y-direction or, optimally, over the entire length 1 of the cell 10 or the third side wall 22, in particular if the cell poles 40, 42 are arranged on a different cell wall. The side tabs 50, 52 can also be formed with a different height H in the z-direction, as is also illustrated by FIG. 2.

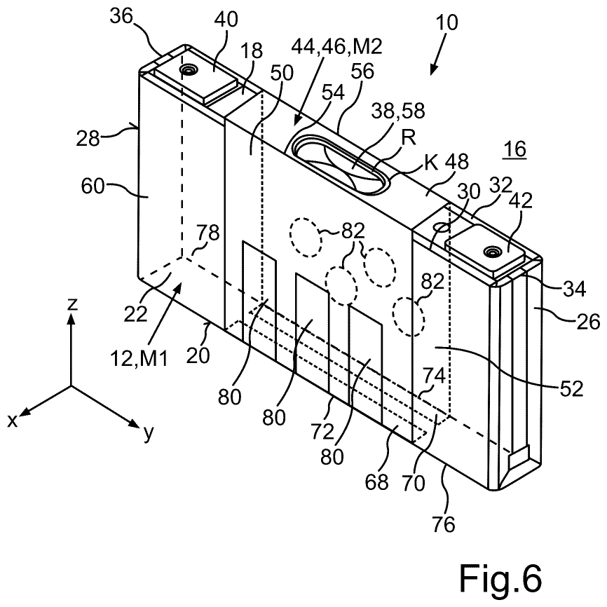

FIG. 2 shows in particular a battery cell 10 according to a further exemplary embodiment of the invention, which can be designed like the battery cell 10 from FIG. 1, except for the difference that the heat protection element 44 has a greater length L and the side tabs 50, 52 have a greater height H. The height H of the side tabs 50, 52 can, for example, be in the range from 0.5 mm to 2 cm and in this example extends to a maximum of half the height h of the cell 10 or the third cell wall 22. The reason for this is that the cell 10, when installed in a module 62 (cf. FIG. 5), is anyway protected laterally in the area of its third and fourth sides 22, 24 by the cell separating elements 64 mentioned above, so that outgassing of the cell 10 in this area is made more difficult by the cell separating elements 64 anyway. The side tabs 50, 52 can also be longer in the z-direction, as described in FIG. 6.

The height H and the length L of the heat protection element 44 can be adapted depending on the situation and can also be varied independently of one another, namely the heat protection element 44 shown in FIG. 1 can, for example, be designed with the length L shown there, but the side tabs 50, 52 can be designed with a greater height H, for example the height H of the side tabs 50, 52 shown in FIG. 2. The heat protection element 44 shown in FIG. 2 can also be made shorter, for example like in FIG. 1, while maintaining its height H in the y-direction.

In addition, the side tabs 50, 52 can be designed to be of different sizes, in particular with regard to their height H. For example, the first side tab 50 can have a greater height H in the z-direction than the second side tab 52 or vice versa.

FIG. 3 shows a schematic cross-sectional illustration of a battery cell 10 according to an exemplary embodiment of the invention. The battery cell 10 can be designed as described above. In this example, the heat protection element 44 is arranged on the outside of the cell housing 12, as previously described, and lies flat against the latter. As can be seen here in particular, the releasable cell degassing opening can be designed with a circumferential edge R that is raised in the z-direction. The boundary contour K surrounding the through-opening 58 in the base element 46, in particular in the base plate 48, can directly border on this edge R of the releasable cell degassing opening 38.

Such a protective plate 44 can be dimensionally adapted to a corresponding cell or its cell housing 12 without great effort and can be applied from the outside to the cell, more precisely to its cell housing 12. For future battery cells, such a protective plate 44 can also already be structurally taken into account in the cell 10 and thus also be already installed within the cell 10, as is shown schematically in FIG. 4, for example.

FIG. 4 shows a schematic representation of a battery cell 10 according to an exemplary embodiment of the invention, according to which the heat protection element 44, which can be designed as described above, is now arranged on the inner side 61 of the cell housing 12.

The heat protection element 44 is therefore located in the interior 14 of the cell housing 12. Nevertheless, it is also arranged flat on the corresponding cell walls 18, 22, 24 and thus again protects above all the edges 54, 56 between the first cell wall 18 and the corresponding third or fourth cell wall 22, 24. In this case, the outer contour K of the through-opening 58 lies directly on the edge R of the releasable cell degassing opening 38, in particular below this edge R with respect to the z-direction.

FIG. 5 shows a schematic illustration of a battery module 62 according to an exemplary embodiment of the invention. The battery module 62 has a cell stack 66 with a plurality of battery cells 10 arranged next to one another in a stacking direction. The battery cells 10 can be designed as described above. The stacking direction corresponds to the x-direction shown.

In addition, the battery module 62 comprises a plurality of cell separating elements 64, wherein one such cell separating element 64 is arranged between each two battery cells 10 adjacent to one another in the stacking direction. This does not extend over the entire height h of a respective battery cell 10 or its third and fourth cell walls 22, 24, but is somewhat shorter in the z-direction. It is therefore very advantageous if the side tabs 50, 52 of the respective heat protection element 44 cover in the z-direction at least that region of the respective third and fourth cell walls 22, 24 not covered by the cell separation elements 64. The tabs 50, 52 can also overlap with the cell separating elements 64, as is illustrated by way of example for the two battery cells 10 on the right shown in FIG. 5.

The cell stack 66 can also be arranged in a housing, which is not shown here. Accordingly, the cell stack 66 can also be limited with respect to the z-direction on the underside, with respect to the x-direction on the left and right and with respect to the y-direction on the front and rear, by corresponding housing walls or housing plates or other components. A corresponding plate-shaped component, for example a housing cover, a carrier plate for the cell connectors, which is also referred to as a busbar carrier, or the like, can also be arranged with respect to the z-direction above the cell stack 66. The housing walls can be used to stabilize the remaining cell walls of the cell housing 12, in particular the second cell wall 20, the fifth and sixth cell walls 26, 28. In combination with the described heat protection element 44, the cell housing 12 can thus be stabilized in its entirety or almost entirely and, in the event of propagation of such a cell 10, the gas outflow can be specifically promoted from the cell degassing opening 38 provided for this purpose.

FIG. 6 shows a schematic and perspective view of a battery cell 10 according to a further embodiment of the invention, wherein the battery cell 10 can be designed as described for FIG. 1 and FIG. 2, except for the differences described below: In this example, the first side tab 50 extends in the z-direction over the entire third cell wall 22 and/or the second side tab 52 extends in the z-direction over the entire fourth cell wall 24, in particular wherein the base element 46 has a first base tab 68 and a second base tab 70 which are opposite the base plate 48 with respect to the z-direction, wherein the first side tab 50 is connected to the first base tab 68 via a third protective edge 72 and the second side tab 52 is connected to the second base tab 70 via a fourth protective edge 74, wherein the first and second base tabs 68, 70 are each arranged on the second cell side 20, in particular lying flat, and the respective third and fourth protective edges 68, 70 overlap with at least part of a respective fifth edge 76 connecting the third and second cell sides 22, 20 and the sixth edge connecting the fourth and second cell sides 24, 20, which is shown in dashed lines here.

This allows these cell walls 22, 24 to be further stabilized and protected from damage when the cell 10 outgasses. In particular, it is also possible to allow the base element 46 to encompass the lower second cell side 20 and thereby to correspondingly also stabilize the fourth edge 76 and/or the fifth edge 78 of the cell housing 12 and to provide a mechanical anchoring for the heat protection element 44.

Furthermore, in this example at least one recess or through-opening 80, 82 is arranged in the first and/or second side tab 50, 52. The through-openings in the first side tab 50 are designated 80, and those in the second side tab 52 are designated 82. The two side tabs 50, 52 can therefore be formed with one or more through-openings 80, 82, e.g. holes that penetrate the respective side tabs 50, 52 in the x-direction. This allows the heat protection element 44 to be made lighter and more cost-effective, which is particularly advantageous when the side tabs 50, 52 extend over the entire third or fourth cell side 22, 24 in the z-direction. Then an additional stabilizing effect can be provided without having to cause significantly more weight and material.

The through-openings 80, 82 can basically have any geometric shape. To illustrate this, the exemplary openings 80 in the first side tabs 50 are angular, in particular rectangular, and the openings 82 in the second side tab 52 are exemplary round, e.g. circular or elliptical.

Openings 80 may also be provided only in the first side tab 50 or only in the second side tab 52. The first side tab 50 can additionally or alternatively be formed with round openings and the second side tab 52 can additionally or alternatively be formed with square openings.

Various other opening geometries, such as triangular, hexagonal, etc. or free-form, are also conceivable.

Overall, the examples show how the invention can provide a propagation protection for prismatic battery cells.

1. A prismatic battery cell, comprising a cell housing made of a first material,
wherein the cell housing has a first and a second cell wall which are opposite one another with respect to a first direction,
a third and a fourth cell wall which are opposite each other with respect to a second direction, and
a fifth and a sixth cell wall which are opposite each other with respect to a third direction,
wherein the first cell wall adjoins the third cell wall via a first edge, adjoins the fourth cell wall via a second edge, adjoins the fifth cell wall via a third edge and adjoins the sixth cell wall via a fourth edge,
wherein the first and second edges are each longer than the third edge and the fourth edge,
wherein the battery cell comprises a releasable cell degassing opening arranged in the first cell wall,
characterized in that
the battery cell has a heat protection element which has a base element which is formed from a second material which has a higher melting point than the first material,
wherein the base element has a first side tab and a second side tab which are opposite one another with respect to the second direction, and a base plate connecting the first and second side tabs via a respective first and second protective edge with a through-opening,
wherein the base plate is arranged flat against the first cell wall or is integrated into the first cell wall so that the through-opening overlaps with the releasable cell degassing opening, and the respective first and second protective edges overlap with at least a part of the respective first and second edges or are integrated into them.

2. The prismatic battery cell according to claim 1, wherein the first side tab lies flat against the third cell wall or is integrated into it and the second side tab lies flat against the fourth cell wall or is integrated into it.

3. The prismatic battery cell according to claim 1, wherein the heat protection element is a separate component from the cell housing and is arranged on an outer side of the cell housing.

4. The prismatic battery cell according to claim 1, wherein the heat protection element is a separate component from the cell housing and is arranged on an inner side of the cell housing in the interior of the cell housing.

5. The prismatic battery cell according to claim 1, wherein the second material has a melting point of at least 1300° C., in particular wherein the second material is a metal, preferably steel or stainless steel.

6. The prismatic battery cell according to claim 1, wherein the base element has a maximum wall thickness of 1 millimeter, preferably 0.5 millimeters.

7. The prismatic battery cell according to claim 1, wherein the first protective edge covers a major part of the first edge in the third direction and the second protective edge covers a major part of the second edge in the third direction.

8. The prismatic battery cell according to claim 1, wherein the first side tab extends in the first direction over the entire third cell wall and/or the second side tab extends in the first direction over the entire fourth cell wall, in particular wherein the base element has a first base tab and a second base tab which are opposite the base plate with respect to the first direction, wherein the first side tab is connected to the first base tab via a third protective edge and the second side tab is connected to the second base tab via a fourth protective edge, wherein the first and second base tabs are each arranged on the second cell side or are integrated therein, and the respective third and fourth protective edge overlap with or are integrated into at least part of a respective fifth edge connecting the third and second cell sides and a sixth edge connecting the fourth and second cell sides.

9. The prismatic battery cell according to claim 1, wherein at least one recess or through-opening is arranged in the first and/or second side tab, in particular in a lower half of the first or second side tab facing away from the base plate.

10. The prismatic battery cell according to claim 1, wherein the heat protection element on the cell housing
is glued thereto; and/or
is clipped thereon; and/or
is held in place by frictional engagement.

11. A battery module with a prismatic battery cell according to claim 1,
characterized in that
the battery module comprises at least one component which is in contact with at least a part of the heat protection element and holds the heat protection element on the outside of the cell housing by means of frictional engagement and/or positive engagement.

12. The prismatic battery cell according to claim 2, wherein the heat protection element is a separate component from the cell housing and is arranged on an outer side of the cell housing.

13. The prismatic battery cell according to claim 2, wherein the heat protection element is a separate component from the cell housing and is arranged on an inner side of the cell housing in the interior of the cell housing.

14. The prismatic battery cell according to claim 3, wherein the heat protection element is a separate component from the cell housing and is arranged on an inner side of the cell housing in the interior of the cell housing.

15. The prismatic battery cell according to claim 2, wherein the second material has a melting point of at least 1300° C., in particular wherein the second material is a metal, preferably steel or stainless steel.

16. The prismatic battery cell according to claim 3, wherein the second material has a melting point of at least 1300° C., in particular wherein the second material is a metal, preferably steel or stainless steel.

17. The prismatic battery cell according to claim 4, wherein the second material has a melting point of at least 1300° C., in particular wherein the second material is a metal, preferably steel or stainless steel.

18. The prismatic battery cell according to claim 2, wherein the base element has a maximum wall thickness of 1 millimeter, preferably 0.5 millimeters.

19. The prismatic battery cell according to claim 3, wherein the base element has a maximum wall thickness of 1 millimeter, preferably 0.5 millimeters.

20. The prismatic battery cell according to claim 4, wherein the base element has a maximum wall thickness of 1 millimeter, preferably 0.5 millimeters.
